(19) United States
(12) Patent Application Publication
(10) Pub. No.: US 2017/0331838 A1
(43) Pub. Date: Nov. 16, 2017

(54) METHODS AND COMPUTING DEVICES TO REGULATE PACKETS IN A SOFTWARE DEFINED NETWORK

(71) Applicant: NOKIA SOLUTIONS AND NETWORKS OY, Espoo (JP)

(72) Inventor: Peter SCHNEIDER, Holzkirchen (DE)

(21) Appl. No.: 15/532,344

(22) PCT Filed: Dec. 1, 2014
(86) PCT No.: PCT/EP2014/076101

§ 371 Date: Jun. 1, 2017

(51) Int. Cl. H04L 29/06; H04L 12/721; H04L 12/713; H04L 12/715

(52) U.S. Cl. CPC H04L 63/126; H04L 45/586; H04L 63/101; H04L 45/34; H04L 63/20; H04L 45/64

(57) ABSTRACT

A method to allow applications to regulate packets in a software defined network includes receiving a request from an application to regulate at least some of the packets, the request including at least one of a destination address range including at least one destination address, and a source address range including at least one source address, for the packets. The method further includes executing the request if it is permitted by at least one permission out of a set of permissions, wherein the permission includes a rule stating at least one type of packet regulation request that is allowed for a set of packets, the set specified by at least one of a source address range and a destination address range, the source address range including at least one source address and the destination address range including at least one destination address. A computing device can be configured to carry out the method.

### TECHNICAL FIELD

Example embodiments disclosed herein relate to communication networks, particularly, to software defined networks.

### Background

### BRIEF DESCRIPTION OF THE DRAWINGS

Example embodiments disclosed throughout the Detailed Description will be described in greater detail with reference to accompanying drawings, in which:

FIG. 1 is a block diagram illustrating a communication system, according to an example embodiment;

FIG. 2 is a block diagram illustrating a communication system, according to an example embodiment; and

FIG. 3 is a flow chart illustrating a method to allow applications to regulate packets in a software defined network.

### DETAILED DESCRIPTION

The embodiments disclosed throughout this Detailed Description are examples. Although this Detailed Description may refer to “an”, “one”, or “some” example embodiment(s) in several locations, this does not necessarily mean that each such reference is to the same example embodiment(s), or that the feature only applies to a single example embodiment. Single features of different example embodiments may also be combined to provide other example embodiments.

The example embodiments disclosed throughout this Detailed Description are applicable to any communication system or any combination of different communication systems and corresponding networks and network elements (including “plug and play” network elements”) that support software defined network (SDN) functionality.

As discussed throughout this Detailed Description, a software defined network can be defined as a communication system including a control plane and a data plane, and in which the control plane is decoupled from the data plane. In the control plane, decisions are made about where traffic is sent. In the data plane, the traffic is forwarded to a destination. For example, in a software defined network, any control functionality that defines a network element as a router and any functionality that defines a network element as a switch is taken out of the router or switch and implemented into an SDN controller. An SDN controller can be defined as software that includes traffic control functionality. In an example embodiment, it may also include hardware. What remains in the router or switch is traffic forwarding functionality. But clearly, as shown in the drawings, there are also functions to communicate with the SDN controller, and to adapt the forwarding function according to the commands received from the SDN controller.

Furthermore, a software defined network is “programmable”. That is, in addition to ensuring proper routing of traffic though an SDN network, an SDN controller provides an interface (typically referred to as a “northbound interface”) to allow applications (also referred to as apps) to control network traffic. Currently, software defined networking is mostly applied to packet based networks, in which the traffic consists of packets, and in which each packet includes a header including the source and the destination of the packet and other header information relevant for the transport of the packet. A traffic flow can be defined as a set of packets sharing at least source or destination header values, and optionally other header values that characterize the particular traffic flow and thus differentiate it from other traffic flows. Through the SDN controller, applications can set rules for traffic flows and thus “program the network”.

In SDN scenarios, there may be multiple different applications manipulating network traffic via an SDN controller, which may either control a single network element or a network including several network elements. The SDN controller provides an interface by which applications can set rules for traffic flows, such as for example blocking a traffic flow, rate limiting a traffic flow, rerouting a traffic flow or assigning bandwidth to a traffic flow. Rules may also be set that do not modify the traffic flow, but perform only reading operations, like reading out a packet counter for a flow. However, to prevent abuse of this network programmability by malicious or erroneous applications, it would be useful to restrict each application suitably by specifying what rules may be set for which traffic flows by each application. It would also be useful for the SDN controller to verify an application's request to set rules before executing it. For example it would be useful for the SDN controller to verify the identity of the requesting application and check whether this application is authorized to set up the requested rules.

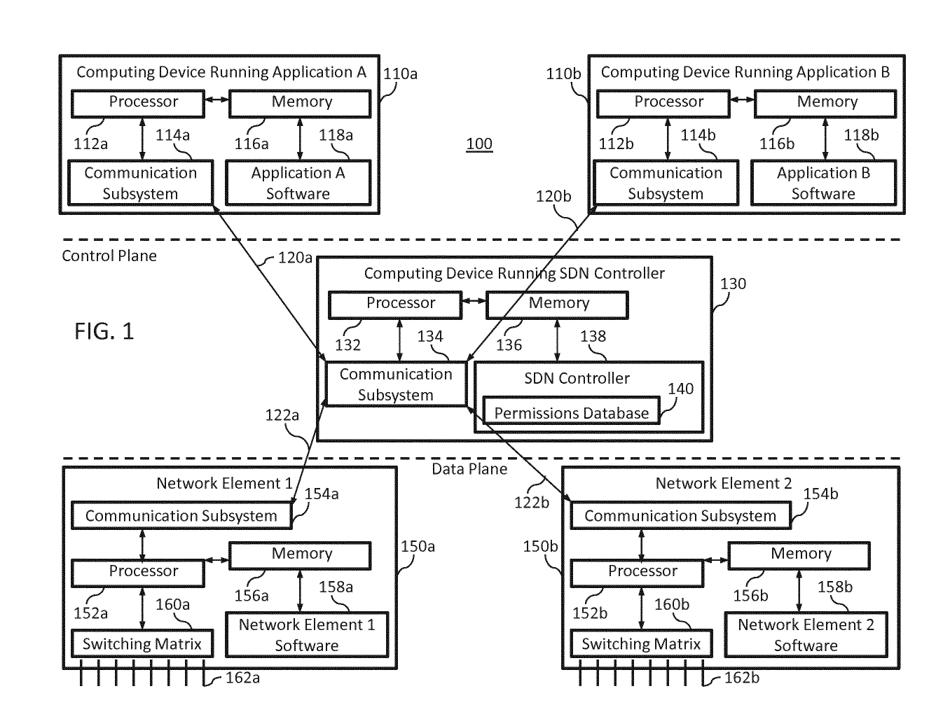

FIG. 1 illustrates an example embodiment communication system 100 of a software defined network, that includes a computing device 110a that is configured to run application A software 118a, a computing device 110b that is configured to run application B software 118b, a computing device 130 configured to run SDN controller 138, and two network elements 150a and 150b. Computing device 130 resides in the control plane of the software defined network. Network elements 1 and 2 reside in the data plane of the software defined network.

In an example embodiment, computing device 110a includes a processor 112a configured to execute application A software 118a. Processor 112a is communicatively connected to and interacts directly or indirectly with memory 116a and communication subsystem 114a. Memory 116a stores application A software 118a. Communication subsystem 114a sends and receives communications (such as for example sending to an SDN controller, a request to regulate at least some packets in the software defined network and receiving a response to the request) to and from processor 112a.

In an example embodiment, communication subsystem 114a (of computing device 110a) is communicatively connected to and interacts directly or indirectly with communication subsystem 134 (of computing device 130) using interface 120a. Accordingly, it is through communication subsystems 114a and 134 and interface 120a, that processor 112a is communicatively connected to and interacts directly or indirectly with processor 132.

In an example embodiment, computing device 110b includes a processor 112b configured to execute application B software 118b. Processor 112b is communicatively connected to and interacts directly or indirectly with memory 116b and communication subsystem 114b. Memory 116b stores application B software 118b. Communication subsystem 114b sends and receives communications (such as for example sending to an SDN controller, a request to regulate at least some packets in the software defined network and receiving a response to the request) to and from processor 112b.

In an example embodiment, communication subsystem 114b (of computing device 110b) is communicatively connected to and interacts directly or indirectly with communication subsystem 134 (of computing device 130) using interface 120b. Accordingly, it is through communication subsystems 114b and 134 and interface 120b, that processor 112b is communicatively connected to and interacts directly or indirectly with processor 132.

In an example embodiment, computing device 130 includes a processor 132 configured to execute SDN controller 138 (which includes permissions database 140 and traffic control functionality software (not shown)). Processor 132 is communicatively connected to and interacts directly or indirectly with memory 136 and communication subsystem 134. Memory 136 stores SDN controller 138. Communication subsystem 134 sends and receives communications (such as for example receiving from an application a request to regulate at least some packets in the software defined network, sending a response to the request, and sending instructions to a network element to execute the request) to and from processor 132.

In an example embodiment, communication subsystem 134 (of computing device 130) is communicatively connected to and interacts directly or indirectly with communication subsystem 154a (of network element 1 150a) using interface 122a. Accordingly, it is through communication subsystems 134 and 154a and interface 122a, that processor 132 is communicatively connected to and interacts directly or indirectly with processor 152a. In an example embodiment, communication subsystem 134 is also communicatively connected to and interacts directly or indirectly with communication subsystem 154b (of network element 2 150b) using interface 122b. Accordingly, it is through communication subsystems 134 and 154b and interface 122b, that processor 132 is communicatively connected to and interacts directly or indirectly with processor 152b.

In an example embodiment, network element 1 150a is a computing device including a processor 152a configured to execute network element 1 software 158a. Processor 152a is communicatively connected to and interacts directly or indirectly with memory 156a, communication subsystem 154a, and switching matrix 160a. Memory 156a stores network element 1 software 158a. Communication subsystem 154a sends and receives communications (such as for example receiving from an SDN controller an instruction to execute an application request and sending a response that the instruction was executed) to and from processor 152a. Switching matrix 160a moves data packets between ports 162a. For example, switching matrix 160a receives incoming data packets at input ports of ports 162a and switching matrix 160a forwards data packets to output ports of ports 162a.

In an example embodiment, network element 2 150b is a computing device including a processor 152b configured to execute network element 2 software 158b. Processor 152b is communicatively connected to and interacts directly or indirectly with memory 156b, communication subsystem 154b, and switching matrix 160b. Memory 156b stores network element 2 software 158b. Communication subsystem 154b sends and receives communications (such as for example receiving from an SDN controller an instruction to execute an application request and sending a response that the request was executed) to and from processor 152b. Switching matrix 160b moves data packets between ports 162b. For example, switching matrix 160b receives incoming data packets at input ports of ports 162b and switching matrix 160b forwards data packets to output ports of ports 162b.

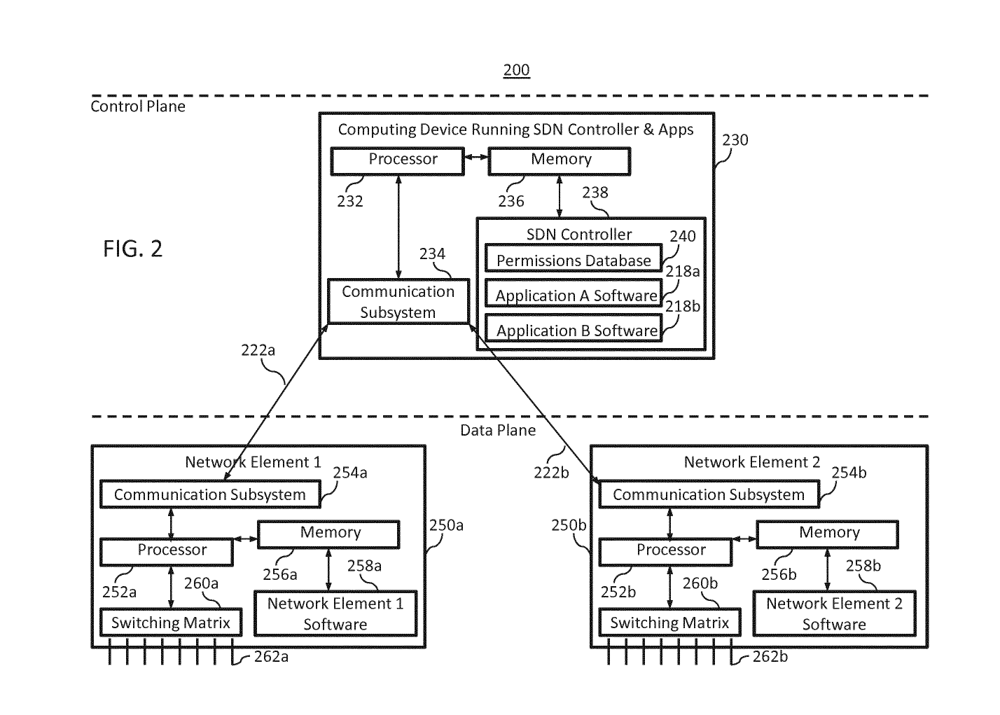

FIG. 2 illustrates an example embodiment communication system 200 of a software defined network, that includes a computing device 230 that is configured to run SDN controller 238, and two network elements 250a and 250b. Computing device 230 resides in the control plane of the software defined network. Network elements 1 and 2 reside in the data plane of the software defined network.

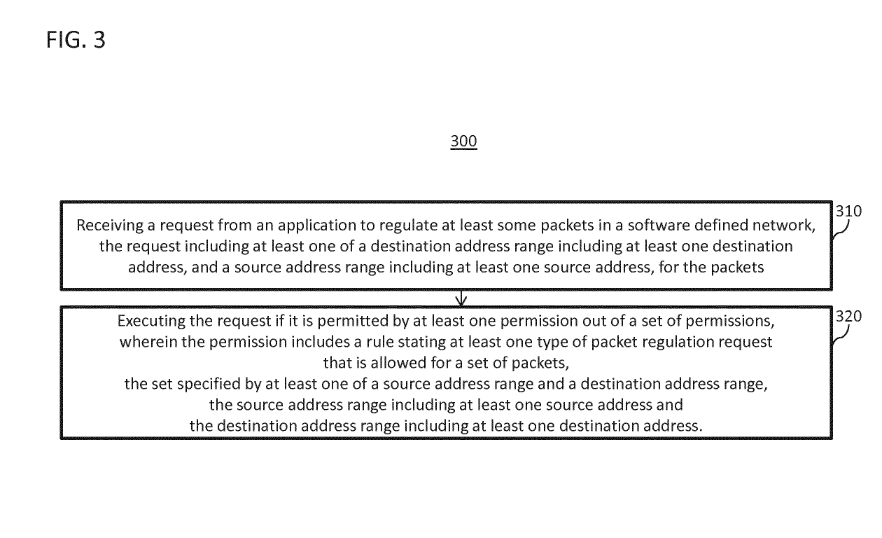

In an example embodiment, computing device 230 is a computing device including a processor 232 configured to run SDN controller 238 (which includes permissions database 240, application A software 218a, application B software 218b, method 300 of FIG. 3, and traffic control functionality software (not shown)). Processor 232 is communicatively connected to and interacts directly or indirectly with memory 236 and communication subsystem 234. Memory 236 stores SDN controller 238. Communication subsystem 234 sends and receives communications (such as for example sending to a network element an instruction to execute an application request and receiving a response that the instruction was executed) to and from processor 232.

In an example embodiment, communication subsystem 234 (of computing device 230) is communicatively connected to and interacts directly or indirectly with communication subsystem 254a (of network element 1 250a) using interface 222a. Accordingly, it is through communication subsystems 234 and 254a and interface 222a, that processor 232 is communicatively connected to and interacts directly or indirectly with processor 252a. In an example embodiment, communication subsystem 234 is also communicatively connected to and interacts directly or indirectly with communication subsystem 254b (of network element 2 250b) using interface 222b. Accordingly, it is through communication subsystems 234 and 254b and interface 222b, that processor 232 is communicatively connected to and interacts directly or indirectly with processor 252b.

In an example embodiment, network element 1 250a is a computing device including a processor 252a configured to execute network element 1 software 258a. Processor 252a is communicatively connected to and interacts directly or indirectly with memory 256a, communication subsystem 254a, and switching matrix 260a. Memory 256a stores network element 1 software 258a. Communication subsystem 254a sends and receives communications (such as for example receiving from an SDN controller an instruction to execute an application request and sending a response that the instruction was executed) to and from processor 252a. Switching matrix 260a moves data packets between ports 262a. For example, switching matrix 260a receives incoming data packets at input ports of ports 262a and switching matrix 260a forwards data packets to output ports of ports 262a.

In an example embodiment, network element 2 250b is a computing device including a processor 252b configured to execute network element 2 software 258b. Processor 252b is communicatively connected to and interacts directly or indirectly with memory 256b, communication subsystem 254b, and switching matrix 260b. Memory 256b stores network element 2 software 258b. Communication subsystem 254b sends and receives communications (such as for example receiving from an SDN controller an instruction to execute an application request and sending a response that the instruction was executed) to and from processor 252b. Switching matrix 260b moves data packets between ports 262b. For example, switching matrix 260b receives incoming data packets at input ports of ports 262b and switching matrix 260b forwards data packets to output ports of ports 262b.

In example embodiments, computing devices 110a, 110b and 130 of FIG. 1 and 230 of FIG. 2 can be a server, or other computing device.

In example embodiments, processors 112a, 112b, 132, 152a and 152b of FIG. 1 and processors 232, 252a and 252b of FIG. 2, each include hardware or software or any combination of hardware or software.

In example embodiments, memories 116a, 116b, 136, 156a and 156b of FIG. 1 and memories 236, 256a, and 256b of FIG. 2 are each persistent stores, such as for example flash memory, read-only (ROM) memory or other similar storage.

In example embodiments, permissions databases 140 of FIG. 1 and 240 of FIG. 2, store permissions. In an example embodiment, a permission includes a rule stating which requests are allowed for a set of packets, the set specified by at least one of a source address range and a destination address range, the source address range including at least one source address and the destination address range including at least one destination address. In an example embodiment, a permission may also include at least one identifier specifying an application for which the permission is applicable.

The permissions databases 140 of FIGS. 1 and 240 of FIG. 2 can be of any type. The database may also store other information besides permissions. It should be appreciated that the content in the database depends on implementation details and configuration of the corresponding SDN controller 138 (of FIG. 1) or 238 (of FIG. 2). Further, it bears no significance where the database, or part of the database, is located, and whether or not some databases are integrated together.

It bears no significance in example embodiments how applications in application A software 118a (of FIG. 1), application A software 218a (of FIG. 2), application B software 118b (of FIG. 1), application A software 218b (of FIG. 2) are implemented (for example, within an SDN controller or outside of an SDN controller).

In example embodiments, interfaces 120a and 120b of FIG. 1 are hyper text transfer protocol (HTTP) or other similar protocol interfaces, and interfaces 122a and 122b of FIGS. 1 and 222a and 222b of FIG. 2, are network control interfaces (such as for example interfaces according to the OpenFlow Switch Specification of the Open Networking Foundation). In example embodiments, any of the interfaces 120, 120b, 122a, 122b, 222a and 222b can be defined by a network operator, or by vendors of the computing devices 110a, 110b, 130 and 230 and network elements 150a, 150b, 250a and 250b, or can be a standardized interface.

Communication systems 100 and 200 may have a more complex architecture; here, only some elements and functions are shown. The illustrated elements and functions are all logical units, whose implementation may differ from what is shown in FIGS. 1 and 2. The connections shown in FIGS. 1 and 2 are logical connections; the actual physical connections may be different. It is apparent to a person skilled in the art that the systems also include other elements and functions, that are not illustrated or discussed in this Detailed Description.

FIG. 3 illustrates an example embodiment method 300 to allow applications to regulate packets in a software defined network. The method 300 can be implemented as software for a processor of a computing device running an SDN controller, such as for example processor 132 of FIG. 1 or processor 232 of FIG. 2.

At 310, a request is received at the SDN controller from an application to regulate at least some packets in a software defined network. For example, if processor 132 (of FIG. 1) were executing method 300, it would receive a request from an application from application A software 118a or application B software 118b. In another example, if processor 232 (of FIG. 2) were executing method 300, it would receive a request from an application from application A software 218a or application B software 218b.

In an example embodiment, the request includes at least one of a destination address range including at least one destination address, and a source address range including at least one source address, for the packets.

At 320, the request is executed, if it is permitted by at least one permission out of a set of permissions. In an example embodiment, a permission includes a rule stating at least one type of packet regulation request that is allowed for a set of packets, the set specified by at least one of a source address range and a destination address range, the source address range including at least one source address and the destination address range including at least one destination address. In example embodiments, rules in the permissions are set by a network operator and/or applications and stored in a permissions database.

The SDN controller can execute the request by itself or instruct one or more network elements to execute the request. The SDN controller can also communicate to the requesting application, a response indicating that the request has been executed. If the request is not permitted by a permission in the permissions database, the SDN controller can communicate to the requesting application, a response indicating that there is lack of permission for the request.

In an example embodiment, a permission includes an operation restriction for the application, such as for example: restricting the application to perform only read operations, restricting the application to only receive notifications of events, allowing the application to perform write operations (such as for example modify the routing of packets, drop packets, modify header information in packets, modify all traffic flows, send packets out, set a device configuration, and set a priority of a traffic flow), or a combination of these operation restrictions.

In example embodiments, permissions are stored in permissions databases, such as databases 140 of FIG. 1 and 240 of FIG. 2. The SDN controller then checks the permissions databases to see if the request is permitted by at least one permission in the permission database.

It would be useful for the SDN controller to identify the application and to verify the origin and the integrity of each request. This verification is useful in order to prevent attackers to impersonate legal applications and set malicious flow rules abusing the access rights of the application. Accordingly, in an example embodiment, a permission includes at least one identifier specifying an application for which the permission is applicable, and the request is associated with an identifier identifying the requesting application. Accordingly, after receiving a request, the SDN controller checks a permissions database to see if a permission exists that has the same identifier as the requesting application. If so, and if the request is permitted by the permission, the SDN controller executes the request.

In an example embodiment, method 300 further includes the SDN controller making a secure connection with the requesting application, using a security protocol that allows to identify and authenticate the requesting application and ensure the integrity of requests received from the requesting application. Examples of such security protocols are transport layer security (TLS), Internet protocol security (IPSec) and secure sockets layer (SSL) protocol. After setting up such a secure connection, the connection is associated with the requesting application, and every request that comes in over the connection is accepted as coming from this application. (Thus, in this example embodiment, there is no need to have an identifier in every request.) Furthermore, the SDN controller accepts the request for further processing if it has been received correctly via the secure connection.

In another example embodiment, when the request is associated with an identifier identifying the requesting application, and the request is cryptographically signed by the requesting application, the method 300 further includes accepting the request for further processing if it can successfully verify the signature. For example, an application can own a private/public key pair. The public key is configured or otherwise transferred to the SDN controller. The application signs each request with its private key and adds the signature to the request. The processor uses the public key to verify the signature. Instead of a public/private key pair, a secret key shared between the application and the SDN controller could also be used. As long as private keys (or shared secret keys) are not disclosed, and the SDN controller maintains securely the association of shared or public keys to applications, an external attacker or an application will not be able to successfully impersonate another application without a fundamental break of the cryptographic algorithm, which is commonly believed to be impossible.

In example embodiments, a timestamp or a sequence number can be used to prevent replay of a valid request by an attacker. Without such protection, an attacker that has intercepted a request may replay it, i.e. send it to the processor at a later time, which could have various undesired effects and could negatively impact an application and the network. Accordingly, in an example embodiment, the request includes a timestamp and method 300 further includes accepting the request for further processing if it is, according to this timestamp, not older then a specified time.

In another example embodiment, the request includes a sequence number and method 300 further includes: comparing the sequence number with at least one sequence number received in preceding requests and accepting the request for further processing if the sequence number is valid according to a chosen policy.

In an example embodiment, the permission includes a rule stating at least one type of packet regulation request that is allowed for a set of packets, and the at least one type of packet regulation request includes at least one of: blocking the packets, rate limiting the packets, diverting the packets to another destination, and reserving a bandwidth for the packets.

In an example embodiment, applications and permissions are included in the communication system or SDN controller before or during runtime. For example, a network operator can use a network element management system to: before runtime, instantiate an SDN controller including applications and permissions associated with the applications; and during runtime of the SDN controller, add additional applications and permissions associated with the additional applications.

In the example communication system 100 of FIG. 1, where application A software 118a and application B software 118b are stored separately from the SDN controller 130, applications could be started and shut down independently from the SDN controller. However, permissions associated with the applications should be stored in the permission database 140 before the applications can successfully communicate requests to the SDN controller.

There are many scenarios in which method 300 of FIG. 3 can be used. For example, this can be used in Internet protocol (IP) networks to allow an organization owning several IP hosts (e.g. a video service provider owning several video servers) connected to the network to set rules only for traffic flows towards this organization's IP hosts, i.e. to traffic flows with an IP address of one of this organization's hosts as the destination address, and to prevent them from setting rules for any other traffic flows. With such a policy, any number of applications provided by different host owners could run in parallel without causing any conflicting traffic flow rule settings in the network. A number of useful operations could be available to host owners in this scenario. For example, a service provider could set rules admitting traffic to its servers only from hosts of the service provider's customers. Or the service provider could selectively block traffic from misbehaving sources. An enterprise organization could implement an enterprise virtual private network (VPN) inside the IP network by setting up rules that allow traffic towards one of its VPN gateways only if it is sent from another VPN gateway of this enterprise. An end user owning a client host could for example run an application that reserves via the SDN controller a certain bandwidth for a flow transporting a high definition video stream towards the client host.

A network operator could also allow more than one application to set rules for the same traffic flow. For example, in addition to allowing owners of hosts connected to the network to set rules for network flows towards their own hosts, as in the example above, a network operator could also allow them to set rules for flows originating from their hosts. With this, for example a video service provider could reserve bandwidth for a video stream towards a customer of the video service provider. However, in this case, conflicting rules may be requested by the sender and the receiver of a traffic flow.

There could also be applications that are allowed to set rules for all traffic flows. Such applications may be part of the network operator's own network control software and execute tasks such as network monitoring and traffic anomaly detection. Such applications may only be allowed to set “read-type” rules to avoid conflicts with rules set by other applications. But there may also be applications that can set “write-type” rules for all flows, like an application isolating hosts that are suspected to be infected with malware, or an anti-spoofing application that drops all network ingress traffic where the source address can be recognized as spoofed.

In case permission policies are used that can lead to conflicting rules for a traffic flow, a mechanism may be used to resolve conflicts. For example, application can be assigned different priorities and conflicts are resolved based on priorities. In such a setup, rules set up by the network operators own control application may have a higher priority than any rules set up by applications of network users.

It is further important that the proposed mechanism allows to assign not only general access rights to specific flows, but also to restrict these access rights to some dedicated types of rules, while forbidding other types. E.g., as mentioned already, applications that are allowed only to set “read-type” rules would not generate conflicts with rules of other applications.

It is also possible to implement much more fine grained policies. All types of rules that are made available to applications by the SDN controller are eligible to be used in the definition of a permission. For example, an application may only be allowed to reserve bandwidth for certain traffic flows, but not be allowed to rate limit or block traffic flows.

If there are rules that can be tuned by parameters, the range of values allowed for a rule can also be part of the permission assigned to an application. For example, if a rule can be set reserving a certain amount of bandwidth for a flow, the maximal bandwidth that can be reserved by an application may be limited, e.g. per flow, or a limit is set for the sum of bandwidth reservations by the application.

In an example scenario, a network operator may itself provide a number of applications. However, the network operator may also offer to other organizations (such as for example organizations that operate IP hosts connected to the SDN network) to provide applications. The network operator provides to the other organizations an application program interface (API), as an interface between the organizations' application and the SDN controller, that include the functions:
F1: block traffic; parameters: source and destination IP address (each a single host or a subnetwork);
F2: rate limit traffic; parameters: source and destination IP address (each a single host or a subnetwork), number of packets per second;
F3: reserve bandwidth for traffic; parameters: source and destination IP address (each a single host or a subnetwork), number of megabits per second;

In the example scenario, one organization provides a video service. A dedicated IP subnetwork with address addr_sn1 operated by the video service provider contains the video servers and is connected to the network operator's network. The video service provider now creates an application App1 to be included in the SDN controller with the purpose to control traffic to and from the video servers. For example, the video service provider wants to block or rate limit offending traffic towards the video servers, and to reserve bandwidth for flows from the video servers to customer hosts connected to the operator network.

In the example scenario, the network operator decides to grant the video service provider all permissions concerning traffic destined to the IP-addresses owned by the video service provider, i.e. addresses within addr_sn1. Moreover, the network operator grants the video service provider the permission to reserve bandwidth for any flow from a video server (i.e. from an address in addr_sn1) to any other hosts. Therefore, the network operator configures these permissions within the permission database of the SDN controller. The entries in the permission database may be described as follows:
Entry A1.1: App1, destination addr_sn1: grant F1, grant F2, grant F3
Entry A1.2: App1, source addr_sn1: grant F3

Subsequently, in the example scenario, the application App1 is started. Each time it performs a call of one of the functions F1 to F3, the SDN controller consults the permission database. If the destination address passed in the call is addr_sn1 or a host address within sna1, the SDN controller executes the function, according to entry A1.1. Otherwise, if the source address passed in the call is addr_sn1 or a host address within addr_sn1, and the function is F3, the SDN controller executes the function, according to entry A1.2. Otherwise the SDN controller does not execute the function and returns an error code to the application App1.

The terms “request” or “requesting”, disclosed throughout the Detailed Description does not imply that a server-client or a master-slave approach is or needs to be used. The terms “requesting” and “request” can be defined as asking and the act of asking. Furthermore, the requests disclosed throughout the Detailed Description are only examples and may even include several separate communications for sending the same information. In addition, the requests may also contain other information.

It will be obvious to a person skilled in the art that, as technology advances, the inventive concept can be implemented in various ways. The invention and its embodiments are not limited to the examples described above but may vary within the scope of the claims.

1. A processor implemented method, to allow applications to regulate packets in a software defined network, comprising:
receiving a request from an application to regulate at least some of the packets, the request including at least one of a destination address range including at least one destination address, and a source address range including at least one source address, for the packets;
executing the request if it is permitted by at least one permission out of a set of permissions, wherein the permission includes a rule stating at least one type of packet regulation requests that is allowed for a set of packets, the set specified by at least one of a source address range and a destination address range, the source address range including at least one source address and the destination address range including at least one destination address.

2. A method according to claim 1, wherein a permission includes at least one identifier specifying an application for which the permission is applicable, and wherein the request is associated with an identifier identifying the requesting application, and wherein the method further comprises executing the request, if a permission exists that has the same identifier that is associated with the requesting application.

3. A method according to claim 2, further comprising:
making a secure connection with the requesting application, using a security protocol that allows to identify and authenticate the requesting application and ensure the integrity of requests received from the requesting application; and
accepting the request for further processing if it has been received correctly via the secure connection.

4. A method according to claim 2, wherein the request is cryptographically signed by the requesting application and the method further comprises accepting the request for further processing if the signature can be successfully verified.

5. A method according to claim 1, wherein the request includes a timestamp, and the method further comprises accepting the request for further processing if it is, according to this timestamp, not older then a specified time.

6. A method according to claim 1, wherein the request includes a sequence number, and the method further comprises:
comparing the sequence number with at least one sequence number received in preceding requests; and
accepting the request for further processing if the sequence number is valid according to a chosen policy.

7. The method according to claim 1, wherein the at least one type of packet regulation request includes at least one of: blocking the packets, rate limiting the packets, diverting the packets to another destination, and reserving a bandwidth for the packets.

8. A computing device to allow applications to regulate packets in a software defined network, comprising:
a processor configured to:
receive a request from an application to regulate at least some of the packets, the request including at least one of a destination address range including at least one destination address, and a source address range including at least one source address, for the packets;
execute the request if it is permitted by at least one permission out of a set of permissions, wherein the permission includes a rule stating at least one type of packet regulation request that is allowed for a set of packets, the set specified by at least one of a source address range and a destination address range, the source address range including at least one source address and the destination address range including at least one destination address.

9. A computing device according to claim 8, wherein a permission includes at least one identifier specifying an application for which the permission is applicable, and wherein the request is associated with an identifier identifying the requesting application, and wherein the processor is further configured to execute the request, if a permission exists that has the same identifier that is associated with the requesting application.

10. A computing device according to claim 9, wherein the processor is further configured to:
make a secure connection with the requesting application, using a security protocol that allows to identify and authenticate the requesting application and ensure the integrity of requests received from the requesting application; and
accept the request for further processing if it has been received correctly via the secure connection.

11. A computing device according to claim 9, wherein the request is cryptographically signed by the requesting application and the processor is further configured to accept the request for further processing if the signature can be successfully verified.

12. A computing device according to claim 8, wherein the request includes a timestamp, and the processor is further configured to accept the request for further processing if it is, according to this timestamp, not older then a specified time.

13. A computing device according to claim 8, wherein the request includes a sequence number, and the processor is further configured to:
compare the sequence number with at least one sequence number received in preceding requests; and
accept the request for further processing if the sequence number is valid according to a chosen policy.

14. A computing device according to claim 8, wherein the at least one type of packet regulation request includes at least one of: blocking the packets, rate limiting the packets, diverting the packets to another destination, and reserving a bandwidth for the packets.

15. A computer readable medium, including instructions to allow applications to regulate packets in a software defined network, wherein execution of the instructions by at least one processor causes the at least one processor to:
receive a request from an application to regulate at least some of the packets, the request including at least one of a destination address range including at least one destination address, and a source address range including at least one source address, for the packets;
execute the request if it is permitted by at least one permission out of a set of permissions, wherein the permission includes a rule stating at least one type of packet regulation request that is allowed for a set of packets, the set specified by at least one of a source address range and a destination address range, the source address range including at least one source address and the destination address range including at least one destination address.
